(19) United States
(12) Patent Application Publication
(10) Pub. No.: US 2013/0127425 A1
(43) Pub. Date: May 23, 2013

(54) ENERGY DISTRIBUTION DEVICE FOR DISTRIBUTING AN ENERGY SIGNAL WITHIN A COMMERCIAL ESTABLISHMENT OR BUILDING

(71) Applicant: James J. Papa, Bryn Mawr, PA (US)

(72) Inventor: James J. Papa, Bryn Mawr, PA (US)

(21) Appl. No.: 13/681,384

(22) Filed: Nov. 19, 2012

Related U.S. Application Data
(60) Provisional application No. 61/561,187, filed on Nov. 17, 2011.

(51) Int. Cl. H02J 7/00; H01F 38/14

(52) U.S. Cl. CPC H02J 7/0052; H01F 38/14
USPC 320/137; 307/104

(57) ABSTRACT

A master beam commercial module U-form energy distributor can wirelessly recharge all electronic devices within a given range. The energy distributor can include a hollow center with a plurality of U-form Wi-Fi/Bluetooth/energy distributors and a disc base. The device can include a company logo, if desire, on the base and a power level indicator. The device can have a port for a power cord and a telephone, CAT-5 or USB type jack, for example, for Wi-Fi/energy input. The master beam commercial module energy distributor can generate a sufficient amount of energy for schools, coffee ships and other such commercial establishments and buildings. To achieve this energy transmission, there can be about ten power output transmitters per side of each of the plurality of U-form energy distributors and typically about four such U-shaped energy distributors can be used, resulting in about 80 power outputs.

### CROSS-REFERENCE TO RELATED APPLICATION

This application claims the benefit of priority of U.S. provisional application No. 61/561,187, filed Nov. 17, 2011, the contents of which are herein incorporated by reference.

### BACKGROUND OF THE INVENTION

The present invention relates to electronic device accessories and, more particularly, to a module that can distribute energy, Wi-Fi, Bluetooth®, or similar signals to wirelessly recharge all electronic devices configured to receive the energy signals to recharge.

Small, portable electronic devices are currently used by nearly everyone in some form. These devices can include cell phones, smart phones, tablet computers, laptop computers, e-readers, portable media/music players, video camera, picture cameras and the like. Each of these devices typically employs a rechargeable battery pack that requires periodic connection to a charger. Many simply forget to connect the equipment to the charger and are left without sufficient power to use their portable electronic devices. Frequently, the portable electronic device is being used in locations where an outlet for the charger is simply not available.

While efforts are made to create standard size charging plugs for many of these devices, there are still many devices that require a special plug for recharging the device. In this case, or in the case where many devices are needed to be charged as once, a user is often faced with the problem of having to find an outlet and place themselves near the outlet at a commercial establishment, so that each of the various electronic devices can be charged. These power cords can be unsightly or even unsafe.

Wireless power transmission is defined as a point-to-point energy or power transmission through a vacuum, the atmosphere, or other media without the use of conductors. Attenuation of the energy from the transmitter to the receiver is not a function of the distance that separates them unless the medium through which the energy travels affects the energy. For example, in a perfect vacuum, the power beam would travel indefinitely, no matter the distance. This can also be referred to as a conductorless power transmission. This is contrary to an induction system, for example, which must have a minimum to zero distance between the induction coils in order to function.

As can be seen, there is a need for a device that can wireless recharge electronic devices safely and effectively, in a defined space.

### SUMMARY OF THE INVENTION

In one aspect of the present invention, an energy distribution device comprises a base member; a plurality of U-arms connected to and extending upward from the base member; and a transmitter system disposed in each of the U-arms, the transmitter system operable to transmit an energy signal therefrom.

In another aspect of the present invention, an energy distribution device comprises a base member; four U-arms connected to and extending upward from the base member; a transmitter system disposed in each of the U-arms, the transmitter system operable to transmit an energy signal therefrom; and a power level indicator providing a visual display corresponding to the power lever of the energy signal, wherein the U-arms includes first and second members extending upward from the base and extending generally parallel to each other at their ends.

In a further aspect of the present invention, a method for wirelessly providing energy to recharge a portable electronic device having a rechargeable battery comprises delivering an energy signal from a transmitter system disposed in a plurality of U-arms attached to a base of an energy distributor device, the transmitter system operable to transmit an energy signal therefrom; and receiving the energy signal into the electronic device to recharge the rechargeable battery therein.

These and other features, aspects and advantages of the present invention will become better understood with reference to the following drawings, description and claims.

### BRIEF DESCRIPTION OF THE DRAWINGS

FIG. 1 is a perspective view of a master beam commercial module U-form energy distributor, in use to wirelessly recharge various portable electronic devices located within range thereof, according to an exemplary embodiment of the present invention;

FIG. 2 is a front view of the master beam commercial module U-form energy distributor of FIG. 1;

FIG. 3 is a forward perspective view of the master beam commercial module U-form energy distributor of FIG. 1; and

FIG. 4 is a rearward perspective view of the master beam commercial module U-form energy distributor of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a master beam commercial module U-form energy distributor that can wirelessly recharge all electronic devices within a given range. The energy distributor can include a hollow center with a plurality of U-form Wi-Fi/Bluetooth/energy distributors (also referred to as simply energy distributors) and a disc base. The device can include a company logo, if desire, on the base and a power level indicator. The device can have a port for a power cord and a telephone, CAT-5 or USB type jack, for example, for Wi-Fi/energy input. The master beam commercial module U-form energy distributor can generate a sufficient amount of energy for schools, coffee ships and other such commercial establishments and buildings. To achieve this energy transmission, there can be about ten power output transmitters per side of each of the plurality of U-form energy distributors and typically about four such U-shaped energy distributors can be used, resulting in about 80 power outputs.

The master beam commercial module U-form energy distributor can help commercial or other large establishments recharge all their electronic devices wirelessly, whether these devices are cell phones, computers or the like. With the device of the present invention, people will no longer have to wait for electronic devices to charge and have to plug them into electrical sockets. Users can use their electronic devices at their convenience and they can even recharge these electronic devices even while they are using it, provided the electronic devices include, either built-in or as an added module, a power receiver system.

The power receiver system can be incorporated in the electronic device and can include an energy receptor capable of receiving the wireless power beam and transferring the energy from the beam to an energy storage device (such as a rechargeable battery) included in the electronic device. The master beam commercial module U-form energy distributor can receive and track a power request signal from the power receiver system of an electronic device to track the power receiver system location during energy transmission. Data streams may be incorporated into the wireless signals of the system of the present invention, allowing the system to function as a communications pathway as well as a power delivery system.

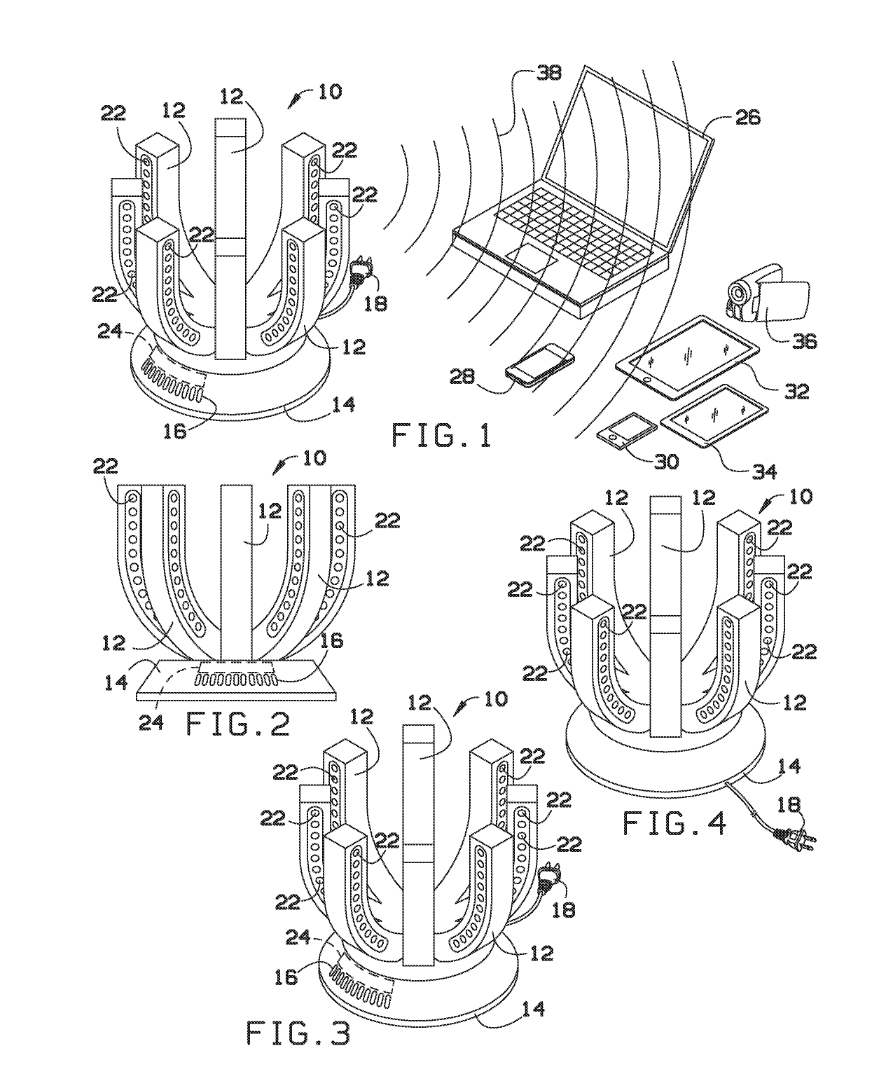

Referring now to FIGS. 1 through 4, a master beam commercial module U-form energy distributor 10 (also referred to simply as device 10, or energy distributor 10) can include a base 14, such as a molded plastic base with a plurality of U-arms 12, typically 4 U-arms for a total of 8 arm segments, connected thereto.

The base 14 can include a power level indicator 16. The power level indicator 16 can provide a visual indication of the power generated and/or output by the energy distributor 10. In some embodiments, the power level indicator 16 can include a plurality of light emitting diodes (LEDs) that can illuminate in a row to indicate power level. Of course, other mechanisms may be used to provide a power level indication to the user.

The device 10 can include a power cord 18 to provide power to the device 10. In some embodiments, the power cord 18 can be omitted and the device 10 can run off a rechargeable battery (not shown). The device 10 can also include an input for an auxiliary signal, such as a Wi-Fi or Bluetooth signal for sending out an energy signal 38 via a Wi-Fi or Bluetooth signal, for example.

The U-arms 12 can be attached to a top side of the base with arms extending upward. While the drawings show a U-shape, the U-arms 12 can take on various similar shapes within the scope of the present invention. For example, the U-arms 12 may be spread wider or narrower of may take on a more rectangular shape, for example.

The U-arms 12 or the base 14 can include a space 24 for displaying a company logo or other indicia. The U-arms 12 can include a transmitter system 22, typically including about 10 power output transmitters per side. Therefore, with 4 U-arms 12 (8 sides), about 80 power output transmitters can be used. The transmitter system 22 can generate and deliver the energy signal 38. The energy signal 38 can be received by electronic devices, such as a laptop 26, a cell phone 28, a mp3 player 30, a tablet computer 32, an e-reader 34, a video camera 36, or other similar portable electronic devices with rechargeable batteries.

The U-arms 12 can include first and second members extending upward from the base and extending generally parallel to each other at their ends. The U-arms 12 can be, for example, from about 4 to about 12 inches high, typically about 8 inches high, and from about 4 to about 12 inches apart, typically about 8 inches apart, at the ends of the U-arms 12.

Various power transmission signals can be transmitted from the transmitter system 22. In some embodiments, a Wi-Fi or Bluetooth signal can be used to transmit energy to the electronic devices. The Wi-Fi or Bluetooth signal can be transmitted through a cable and into the device 10. The transmitter system 22 can then shoot out the energy signal 38 within a given range, such as within a commercial establishment. Electronic devices, equipped with an adapter to receive the energy signal, can be charged, wirelessly, by this energy signal 38 delivered from the energy distributor 10.

While the above mentions the use of the device 10 in commercial establishments, the device 10 can be used in other environments, such as on aircraft, buses, trains, offices, schools and the like. The device 10 can be placed inconspicuously in a room to provide the energy signal 38 to wireless charge electronic devices.

It should be understood, of course, that the foregoing relates to exemplary embodiments of the invention and that modifications may be made without departing from the spirit and scope of the invention as set forth in the following claims.

What is claimed is:

1. An energy distribution device comprising:
a base member;
a plurality of U-arms connected to and extending upward from the base member;
a transmitter system disposed in each of the U-arms, the transmitter system operable to transmit an energy signal therefrom.

2. The energy distribution device of claim 1, wherein the plurality of U-arms is four U-arms.

3. The energy distribution device of claim 1, wherein the transmitter system includes ten transmitters on each side of the U-arms.

4. The energy distribution device of claim 1, further comprising a logo space disposed along the base.

5. The energy distribution device of claim 1, further comprising a power level indicator.

6. The energy distribution device of claim 5, wherein the power level indicator provides a visual display corresponding to the power lever of the energy signal.

7. The energy distribution device of claim 1, wherein each of the U-arm includes first and second members extending upward from the base and extending generally parallel to each other at their ends.

8. The energy distribution device of claim 7, wherein each of the first and second members extend from about 4 to about 12 inches above the base.

9. The energy distribution device of claim 7, wherein each of the first and second members extend from about 8 inches above the base.

10. An energy distribution device comprising:
a base member;
four U-arms connected to and extending upward from the base member;
a transmitter system disposed in each of the U-arms, the transmitter system operable to transmit an energy signal therefrom; and
a power level indicator providing a visual display corresponding to the power lever of the energy signal,
wherein the U-arms includes first and second members extending upward from the base and extending generally parallel to each other at their ends.

11. The energy distribution device of claim 10, wherein the transmitter system includes ten transmitters on each side of the U-arms.

12. The energy distribution device of claim 10, further comprising a logo space disposed along the base.

13. The energy distribution device of claim 10, wherein each of the first and second members extend from about 8 inches above the base.

14. A method for wirelessly providing energy to recharge a portable electronic device having a rechargeable battery, the method comprising:
delivering an energy signal from a transmitter system disposed in a plurality of U-arms attached to a base of an energy distributor device, the transmitter system operable to transmit an energy signal therefrom; and
receiving the energy signal into the electronic device to recharge the rechargeable battery therein.

15. The method of claim 14, wherein the energy signal is a Wi-Fi signal.

16. The method of claim 14, further comprising providing a visual display corresponding to the power lever of the energy signal.
